(19) United States
(12) Patent Application Publication
(10) Pub. No.: US 2025/0216837 A1
(43) Pub. Date: Jul. 3, 2025

(54) MILKING PLANT CONFIGURATION SYSTEM, COMPUTER-IMPLEMENTED METHOD, COMPUTER PROGRAM AND NON-VOLATILE DATA CARRIER

(71) Applicant: DELAVAL HOLDING AB, Tumba (SE)

(72) Inventors: Axel ELFGREN, Tumba (SE); Jörgen ENICKL, Tumba (SE); Lars LILJEGREN, Tumba (SE); Per PERSSON, Tumba (SE); Günter SCHLAISS, Tumba (SE); Ian VILA, Tumba (SE)

(21) Appl. No.: 18/867,279

(22) PCT Filed: May 16, 2023
(86) PCT No.: PCT/SE2023/050480

§ 371 Date: Nov. 19, 2024

(30) Foreign Application Priority Data
May 20, 2022 (SE) 2250607-5

(51) Int. Cl. G05B 19/418

(52) U.S. Cl. CPC G05B 19/41835; G05B 2219/45113

(57) ABSTRACT

A system for configuring the components in milking plants at different farms, each of which components is operatively connected to a respective configurable controller. A central server (110) generates a first configuration file (CF{ID1}) based on a first milking plant specification (S{ID1}) identifying components in a first set of farm components (141, 142, 143) at a first farm (150). A portable computer (130) is temporarily connected to the central server (110); and while connected, the portable computer (130) receives the first configuration file (CF{ID1}) from the central server (110). Thereafter, the portable computer (130) is temporarily connected to at least one configurable controller (C1, C2, C3) at the first farm (150), either directly or via a first local server (120) and a first local network (125). While connected, the portable computer (130) transfers a set of configuration parameters (CF1, CF2, CF3) to the at least one of the configurable controllers (C1, C2, C3), which set of configuration parameters is comprised in the first configuration file (CF{ID1}). Thus, a configuration of the configurable controller (C1, C2, C3) is set in accordance with the received respective set of configuration parameters (CF1, CF2, CF3) for that configurable controller (C1, C2, C3).

### TECHNICAL FIELD

The present invention relates generally to configuration of milking plants. Especially, the invention relates to a milking plant configuration system for programming farm components being operatively connected to a respective configurable controller according to the preamble of claim 1 and a corresponding computer-implemented method. The invention also relates to a computer program and a non-volatile data carrier storing such a computer program.

### BACKGROUND

Today's milking systems are highly complex installations in which a multitude of components and pieces of equipment must interact according to a number of well-tuned processes. Thus, setting up and organizing a modern milking system in a functionally optimized manner is a complex and often very time-consuming task. Therefore, a highest possible degree of automation of this task is generally desirable.

WO 2020/251456 shows a control unit and configuration tag of a milk analysis apparatus that includes a first wireless communication device for communication with a memory device of the configuration tag. The configuration tag is applicable to the milk analysis apparatus and comprises a reference sign of a milk extracting arrangement to which the milk analysis apparatus is intended to work in conjunction with. The communication is made via a second wireless communication device comprised in the configuration tag. The control unit is configured to retrieve configuration data, e.g. a network location reference such as an IP address, of the milk extracting arrangement that the milk analysis apparatus is intended to operate in conjunction with, from the memory device of the configuration tag via the first wireless communication device; and to configure the control unit, based on the retrieved configuration data of the milk extracting arrangement.

EP 2 840 887 describes a method for controlling devices within an agricultural network system via a network bus such as a physical network bus or a logical network bus, wherein the devices are controlled by means of control information which is transmitted to the devices by means of messages comprising a content and a header title. The method involves: determining a function for performing thereof by a device in the network, determining the content of a message to be transmitted, and compiling header title information for inclusion thereof in a header title for the message to be transmitted. The header title information contains a predetermined number of data fields, such as preferably a network identifier, a device type designation, a function designation, a location designation and/or a group designation, for the purpose of determining on the basis of compliance with one or more of these data fields which device or devices receive(s) the message.

Thus, there exist solutions for adapting and programming agricultural systems, e.g. in the form of a milk analysis apparatus. However, there is no convenient way to configure a milking plant that lacks communicative connection to external programming resources.

### SUMMARY

The object of the present invention is therefore to offer a solution that enables a communicatively isolated milking plant to be configured in a straightforward and efficient manner.

According to one aspect of the invention, the object is achieved by a milking plant configuration system for programming farm components, which are operatively connected to a respective configurable controller. The milking plant configuration system includes a central server and a portable computer. The central server is configured to generate a first configuration file based on a first milking plant specification identifying components in a first set of farm components at a first farm. The portable computer is configured to be temporarily connected to the central server; and while the portable computer is connected to the central server, the portable computer is configured to receive the first configuration file from the central server. Subsequently, the portable computer is configured to be temporarily connected to at least one configurable controller at the first farm, either directly or via a first local server and a first local network. While the portable computer is connected to the at least one of the configurable controllers, the portable computer is configured to transfer a set of configuration parameters to the at least one of the configurable controllers so as to set a configuration of the configurable controller in accordance with the received respective set of configuration parameters for that configurable controller, which set of configuration parameters is comprised in the first configuration file.

This system is advantageous because it allows any milking plant with configurable controllers to be functionally set up in an automatic manner even if the milking plant is devoid of communication interfaces to external programming resources, e.g. due to lacking Internet connection.

According to one embodiment of this aspect of the invention, the system contains the first local server and the first local network communicatively connecting the first local server to each of the at least one of the configurable controllers. Further, the first local server is configured to be temporarily connected to the portable computer; receive the first configuration file from the portable computer while being connected thereto; and in response to receiving the first configuration file, transmit the respective set of configuration parameters to each of the respective configurable controllers via the first local network. This design is beneficial because the portable computer only needs to be connected to a single point at the milking plant, namely the first local server.

According to another embodiment of this aspect of the invention, the system also includes a database communicatively connected to the central server. The database contains the first milking plant specification and at least one second milking plant specification identifying components in a second set of farm components at a second farm. Moreover, the portable computer is configured to receive the second configuration file from the central server while the portable computer is temporarily connected to the central server; and subsequently, be temporarily connected to at least one configurable controller at the second farm. Analogous to the above, the portable computer is either connected directly to the at least one configurable controller, or via a second local server and a second local network. While the portable computer is connected to the at least one of the configurable controllers, the portable computer is configured to transfer a set of configuration parameters to the at least one of the configurable controllers at the second farm. As a result, a configuration of the configurable controller at the second farm is set in accordance with a respective set of configuration parameters comprised in the second configuration file. This design is advantageous because before a service technician leaves a base office, he/she may load the portable computer with the configuration parameters for two or more farms; and then head out on a trip with stops at each of said farms. Thereby, the milking plants of a multitude of farms can be configured in a logistically efficient manner.

According to yet another embodiment of this aspect of the invention, the configurable controllers is at least one of: a milking controller operatively connected to a milking parlor; a cleaning controller operatively connected to a cleaning arrangement configured to perform a clean-in-place procedure in respect of at least a part of the milking parlor; and a cooling controller operatively connected to a cooling tank configured to hold extracted milk. Thus, essentially all functions of a modern milking plant are configurable via the portable computer.

Preferably, the milking parlor, in turn, further contains at least one milking point that is connected to a vacuum source, at least one pulsator and at least one milk meter, and the milking controller is configured to monitor the at least one milking point, the vacuum source, the at least one pulsator and at the least one milk meter. Additionally, the cooling tank may contain at least one agitating member, an evaporator and a compressor; and the cooling controller may be configured to monitor the at least one agitating member, the evaporator and the compressor.

According to still another embodiment of this aspect of the invention, the portable computer is configured to obtain a respective status message while the portable computer is connected to each of the configurable controllers, either directly or via the first local server and the first local network. The respective status message indicates a respective current configuration of the configurable controller and/or at least one time stamped measurement value registered by the respective configurable controller. Moreover, the portable computer is configured to transfer a status file to the central server while the portable computer is connected to the central server again. The status file contains at least one of said respective status messages. Thereby, status information from a large number of milking plants may be conveniently gathered, e.g. for centralized analysis.

According to another aspect of the invention, the object is achieved by a computer-implemented method for programming farm components being operatively connected to a respective configurable controller, which method is performed in in at least one processor in a portable computer and at least one processor in a central server. The method involves generating, in the central server, a first configuration file based on a first milking plant specification identifying components in a first set of farm components at a first farm. Then, the method involves receiving, in the portable computer, the first configuration file from the central server while the portable computer is temporarily connected to the central server. Subsequently, the method involves transferring a set of configuration parameters from the portable computer to the at least one of the configurable controllers while the portable computer is temporarily connected to at least one configurable controller at the first farm. The set of configuration parameters are either transferred directly from the portable computer to the at least one of the configurable controllers, or via a first local server and a first local network. In response to said transfer, a configuration of the configurable controller is set in accordance with the received respective set of configuration parameters for that configurable controller. The set of configuration parameters, in turn, is comprised in the first configuration file.

The advantages of this method, as well as the preferred embodiments thereof, are apparent from the discussion above with reference to the proposed system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows how a portable computer is temporarily connected to a central server and then temporarily connected to a first local server according to one embodiment of the invention;

FIG. 2 shows a block diagram of the central server according to one embodiment the invention; and

FIG. 3 illustrates, by means of a flow diagram, the general method according to the invention.

### DETAILED DESCRIPTION

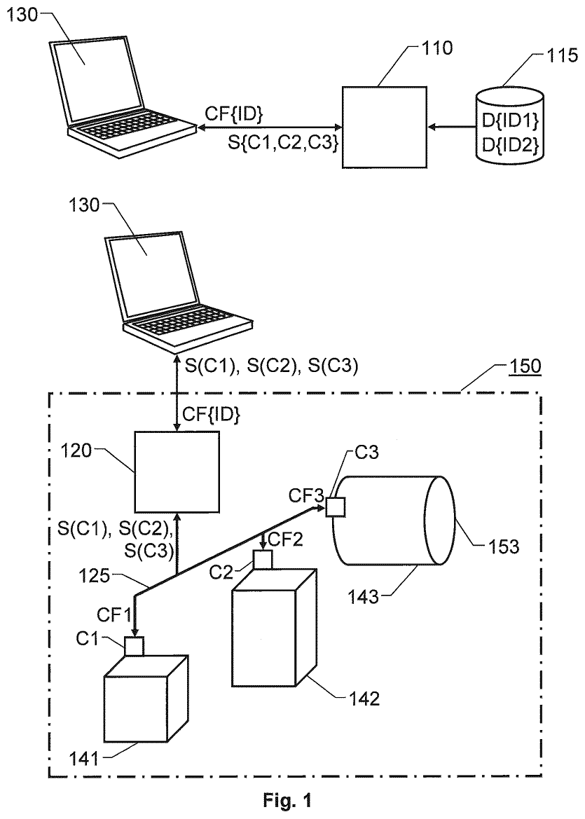

In FIG. 1, we see an overview of milking plant configuration system according to one embodiment of the invention for programming various farm components that are operatively connected to a respective configurable controller. The system contains a central server 110 and a portable computer 130.

The central server 110 is configured to generate a first configuration file CF{ID1} based on a first milking plant specification S{ID1}. The first milking plant specification S{ID1}, in turn, identifies the components in a first set of farm components at a first farm 150. For example, the components may be a milking parlor, a cleaning arrangement and/or a cooling tank, here generically illustrated by reference numerals 141, 142 and 143 respectively.

The portable computer 130 is configured to be temporarily connected to the central server 110. While the portable computer 130 is connected to the central server 110, the portable computer 130 is configured to receive the first configuration file CF{ID1} from the central server 110. Analogously, while the portable computer 130 is connected to the central server 110, the central server 110 is configured to transfer the first configuration file CF{ID1} to the portable computer 130, for example from a database 115 communicatively connected to the central server 110.

Subsequently, i.e. after that the first configuration file CF{ID1} has been received in the portable computer 130, the portable computer 130 is configured to be temporarily connected to at least one configurable controller at the first farm 150, for example C1, C2 and/or C3. In practice, this typically means that a service technician brings the portable computer 130 from a base office out to the first farm 150.

Depending on whether or not the first farm 150 has a first local server 120 that is connected to the configurable controllers via a first local network 125, the portable computer 130 is either connected directly to each respective configurable controller, or via the first local server 120 and the first local network 125. Naturally, the latter alternative is more efficient, especially if the number of configurable controller is relatively large.

In any case, while the portable computer 130 is connected to the at least one of the configurable controllers C1, C2 and C3, the portable computer 130 is configured to transfer a set of configuration parameters CF1, CF2 and CF3 to the at least one of the configurable controllers C1, C2 and C3 respectively. Thereby, a configuration of each of the configurable controller C1, C2 and C3 is set in accordance with the received respective set of configuration parameters CF1, CF2 and CF3 for that configurable controller C1, C2 and C3 respectively. The set of configuration parameters is comprised in the first configuration file CF{ID1}, and may or may not be pre-processed in the portable computer 130 before being transferred to the respective configurable controller C1, C2 or C3.

Specifically, if the first farm 150 is equipped with the above-mentioned first local server 120 and first local network 125 communicatively connecting the first local server 120 to each of the at least one of the configurable controllers C1, C2 and C3, the first local server 120 is configured to perform the following.

First, the first local server 120 is configured to be temporarily connected to the portable computer 130. While being connected thereto, the first local server 120 is configured to receive the first configuration file CF{ID1} from the portable computer 130. In response to receiving the first configuration file CF{ID1}, the first local server 120 is configured to transmit the respective set of configuration parameters CF1, CF2 and CF3 to each of the respective configurable controllers C1, C2 and C3 via the first local network 125. Consequently, all the configurable controllers C1, C2 and C3 may be set to a new respective configuration in a very convenient manner, basically by just plugging the portable computer 130 into the first local server 120.

According to one embodiment of the invention, the milking plant configuration system includes the database 115, which is communicatively connected to the central server 110. The database 115 contains the first milking plant specification S{ID1}. In addition, the database 115 contains at least one second milking plant specification S{ID2} identifying components in a second set of farm components at a second farm (not shown).

While the portable computer 130 is temporarily connected to the central server 110, the portable computer 130 is further configured to receive the second configuration file CF{ID2}, as well as any other relevant configuration files from the database 115 via the central server 110.

Subsequently, i.e. after that the at least one second milking plant specification S{ID2} has been received in the portable computer 130, the portable computer 130 is configured be temporarily connected to at least one configurable controller at the second farm, either before or after being temporarily connected to the at least one configurable controller at the first farm.

Analogous to the above, the portable computer 130 may either be connected directly to each respective configurable controller at the second farm, or via a second local server and a second local network. While the portable computer 130 is connected to the at least one of the configurable controllers at the second farm, the portable computer 130 is configured to transfer a set of configuration parameters to the at least one of the configurable controllers at the second farm so as to set a configuration of the configurable controller at the second farm in accordance with a respective set of configuration parameters comprised in the second configuration file.

According to one embodiment of the invention, one of the configurable controllers C1, C2 and C3 is a milking controller operatively connected to a milking parlor; another one is a cleaning controller operatively connected to a cleaning arrangement configured to perform a clean-in-place procedure in respect of at least a part of the milking parlor, and/or yet another one is a cooling controller operatively connected to a cooling tank configured to hold extracted milk.

Preferably, the milking parlor, in turn, further contains at least one milking point that is connected to a vacuum source, at least one pulsator and/or at least one milk meter. Here, the milking controller may be configured to monitor each of the at least one milking point, the vacuum source, the at least one pulsator and/or at the least one milk meter. In other words, a single controller may be configured to control and/or supervise multiple functions of the milking plant.

Preferably, the cooling tank contains at least one agitating member, an evaporator and/or a compressor. Analogous to the above, the cooling controller may be configured to monitor each of the at least one agitating member, the evaporator and/or the compressor.

According to one embodiment of the invention, data are also transferred in a direction opposite to the one described above, i.e. from the configurable controllers C1, C2 and C3 to the central server 110. This is effected as follows.

While the portable computer 130 is connected to each of the configurable controllers C1, C2 and C3, either directly or via the first local server 120 and the first local network 125, the portable computer 130 is configured to obtain a respective status message S(C1), S(C2) and S(C3) from the configurable controllers C1, C2 and C3 respectively. The status messages S(C1), S(C2) and S(C3) indicate a respective current configuration of the configurable controller C1, C2 and C3 and/or at least one time stamped measurement value registered by the respective configurable controller C1, C2 and C3 respectively.

Then, while the portable computer 130 is re-connected to the central server 110, the portable computer 130 is configured to transfer a status file S{C1,C2, C3} to the central server 110, which status file S{C1, C2, C3} contains at least one of the status messages S(C1), S(C2) and S(C3).

Thereby, the central server 110 may keep track of and verify that each configurable controller C1, C2 and C3 is configured correctly. It is also possible to gather status information from a large number of milking plants and perform centralized analyses in the central server 110.

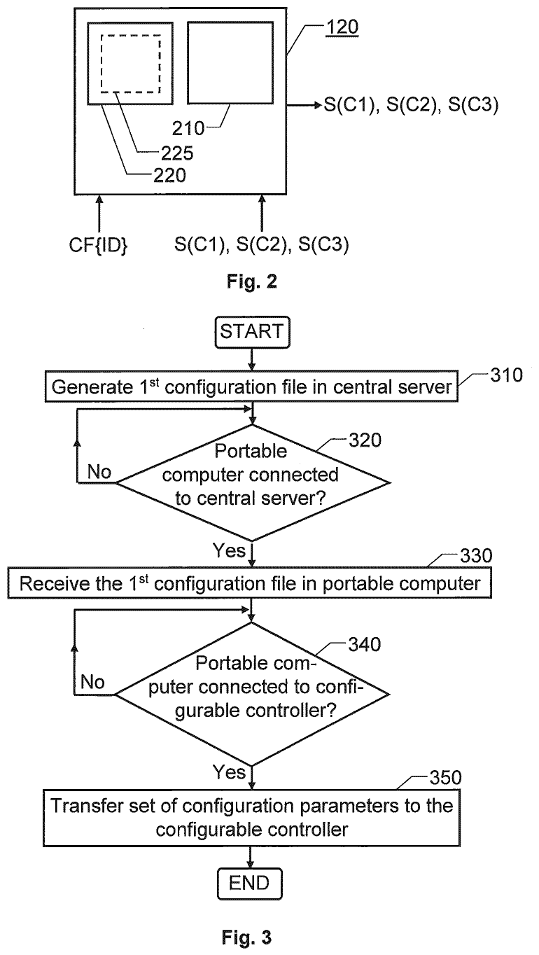

FIG. 2 shows a block diagram of the central server 110 according to one embodiment the invention. It is generally advantageous if the central server 110 is configured to effect the above-described procedure in an automatic manner by executing a computer program 225. Therefore, the central server 110 may include a memory unit 220, i.e. non-volatile data carrier, storing the computer program 225, which, in turn, contains software for making processing circuitry in the form of at least one processor 210 in the central server 110 execute the actions mentioned in this disclosure when the computer program 225 is run on the at least one processor 210.

In order to sum up, and with reference to the flow diagram in FIG. 3, we will now describe the computer-implemented method according to the invention which is performed in the central server 110 and the portable computer 130 respectively.

In a first step 310, the central server 110 generates a first configuration file CF{ID1} based on a first milking plant specification S{ID1} identifying components in a first set of farm components 141, 142 and 143 at a first farm 150. The first configuration file CF{ID1}, in turn, may be obtained from a database 115 communicatively connected to the central server 110.

A subsequent step 320 checks if a portable computer 130 has been connected to the central server 110. If so, a step 330 follows, and otherwise the procedure loops back and stays in step 320.

In step 330, the portable computer 130 receives the first configuration file CF{ID1} from the central server 110 while the portable computer 130 is temporarily connected to the central server 110.

Thereafter, a step 340 checks if the portable computer 130 has been connected to a configurable controller at the first farm, either directly or via a local server 120 and a local network 125. If so, a step 350 follows, and otherwise the procedure loops back and stays in step 340.

In step 350, respective configuration parameters CF1, CF2 and CF3 are transferred from the portable computer 130 to each of at least one configurable controller C1, C2 and C3 while the portable computer 130 is temporarily connected to the at least one configurable controller C1, C2 and C3 at the first farm 150. In response to transferring the configuration parameters CF1, CF2 and CF3 to the configurable controllers C1, C2 and/or C3, a respective configuration of the configurable controller C1, C2 and/or C3 is set in accordance with the received respective configuration parameters CF1, CF2 and/or CF3 for that configurable controller C1, C2 and C3. The configuration parameters are comprised in the first configuration file CF{ID1}).

The process steps described with reference to FIG. 3 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage.

Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A milking plant configuration system for programming farm components, the farm components being operatively connected to a respective configurable controllers, the milking plant configuration system comprising:
a central server (110) configured to generate a first configuration file (CF{ID1}) based on a first milking plant specification (S{ID1}) identifying the components in a first set of the farm components (141, 142, 143) at a first farm (150),
a portable computer (130) configured to:
be temporarily connected to the central server (110); and while the portable computer (130) is connected to the central server (110), the portable computer (130) is configured to receive the first configuration file (CF{ID1}) from the central server (110), and subsequently
be temporarily connected to at least one of the configurable controllers (C1, C2, C3) at the first farm (150), either directly or via a first local server (120) and a first local network (125), and while the portable computer (130) is connected to the at least one of the configurable controllers (C1, C2, C3), transfer a set of configuration parameters (CF1, CF2, CF3) to the at least one of the configurable controllers (C1, C2, C3) so as to set a configuration of a given one of the configurable controllers (C1, C2, C3) in accordance with a given one of the received respective set of configuration parameters (CF1, CF2, CF3) for the given one of the configurable controllers (C1, C2, C3), said set of configuration parameters being comprised in the first configuration file (CF{ID1}).

2. The milking plant configuration system according to claim 1, wherein the system comprises the first local server (120) and the first local network (125) communicatively connecting the first local server (120) to each of the at least one of the configurable controllers (C1, C2, C3), wherein the first local server (120) is configured to:
be temporarily connected to the portable computer (130),
receive the first configuration file (CF{ID1}) from the portable computer (130) while being connected thereto, and in response to receiving the first configuration file (CF{ID1})
transmit the respective set of configuration parameters (CF1, CF2, CF3) to each of the respective configurable controllers (C1, C2, C3) via the first local network (125).

3. The milking plant configuration system according to claim 1, further comprising:
a database (115) communicatively connected to the central server (110), said database (115) comprising the first milking plant specification (S{ID1}) and at least one second milking plant specification (S{ID2}) identifying the components in a second set of the farm components at a second farm, and
the portable computer (130) is further configured to:
receive a second configuration file (CF{ID2}) from the central server (110) while the portable computer (130) is temporarily connected to the central server (110); and subsequently
be temporarily connected to at least one of the configurable controllers at the second farm, either directly or via a second local server and a second local network, and while the portable computer (130) is connected to said at least one of the configurable controllers transfer a second set of configuration parameters to said at least one of the configurable controllers at the second farm so as to set a configuration of at least one of the configurable controllers at the second farm in accordance with the second set of configuration parameters comprised in the second configuration file.

4. The milking plant configuration system according to claim 1, wherein the configurable controllers (C1, C2, C3) comprise at least one of:
a milking controller operatively connected to a milking parlor,
a cleaning controller operatively connected to a cleaning arrangement configured to perform a clean-in-place procedure in respect of at least a part of the milking parlor, and
a cooling controller operatively connected to a cooling tank configured to hold extracted milk.

5. The milking plant configuration system according to claim 4, wherein:
the milking parlor further comprises at least one milking point that is connected to a vacuum source, at least one pulsator and at least one milk meter, and the milking controller is configured to monitor the at least one milking point, the vacuum source, the at least one pulsator and at the least one milk meter; and
the cooling tank comprises at least one agitating member, an evaporator and a compressor; and the cooling controller is configured to monitor the at least one agitating member, the evaporator and the compressor.

6. The milking plant system according to claim 1, wherein:
the portable computer (130) is configured to obtain a respective status message (S(C1), S(C2), S(C3)) while the portable computer (130) is connected to each given one of the configurable controllers (C1, C2, C3), either directly or via the first local server (120) and the first local network (125), said respective status message (S(C1), S(C2), S(C3)) indicating at least one of:
a respective current said configuration of the given configurable controller (C1, C2, C3), and
at least one time stamped measurement value registered by the given configurable controller (C1, C2, C3);
and
the portable computer being configured to transfer a status file (S{C1,C2,C3}) to the central server (110) while the portable computer (130) is connected to the central server (110), said status file (S{C1,C2,C3}) comprising at least one of said respective status messages (S(C1), S(C2), S(C3)).

7. A computer-implemented method for programming farm components that are operatively connected to a respective configurable controllers, which method is performed in at least one processor in a portable computer (130) and at least one processor in a central server (110), the method comprising:
generating, in the central server (110), a first configuration file (CF{ID1}) based on a first milking plant specification (S{ID1}) identifying the components in a first set of the farm components (141, 142, 143) at a first farm (150),
receiving, in the portable computer (130), the first configuration file (CF{ID1}) from the central server (110), while the portable computer (130) is temporarily connected to the central server (110); and subsequently
transferring a set of configuration parameters (CF1, CF2, CF3) from the portable computer (130) to the at least one of the configurable controllers (C1, C2, C3) while the portable computer (130) is temporarily connected to at least one configurable controller (C1, C2, C3) at the first farm (150), either directly or via a first local server (120) and a first local network (125), so as to set a configuration of a given one of the configurable controllers (C1, C2, C3) in accordance with the received respective set of configuration parameters (CF1, CF2, CF3) for the given one of the configurable controllers (C1, C2, C3), said set of configuration parameters being comprised in the first configuration file (CF{ID1}).

8. The method according to claim 7, wherein the first local server (120) and the first local network (125) communicatively connect the first local server (120) to each of the at least one of the configurable controllers (C1, C2, C3), the method further comprising:
receiving the first configuration file (CF{ID1}) in the first local server from the portable computer (130) when the portable computer (130) is temporarily connected to the first local server (120) and in response to receiving the first configuration file (CF{ID1})
transmitting the respective set of configuration parameters (CF1, CF2, CF3) from the first local server (120) to each of the respective configurable controllers (C1, C2, C3) via the local network (125).

9. The method according to claim 7, further comprising:
obtaining the first milking plant specification (S{ID1}) and at least one second milking plant specification (S{ID2}) identifying the components in a second set of the farm components at a second farm in the central server (110) from a database (115) communicatively being connected to the central server (110)
receiving a second configuration file (CF{ID2}) from the central server (110) while the portable computer (130) is temporarily connected to the central server (110); and subsequently
transferring a second set of configuration parameters to at least one said configurable controller at the second farm, either directly or via a second local server and a second local network while the portable computer (130) is temporarily connected to the at least one configurable controller at the second farm, either directly, or via a second local server and a second local network, so as to set a configuration of at least one the configurable controllers at the second farm in accordance with the second set of configuration parameters comprised in the second configuration file.

10. The method according to claim 7, wherein the configurable controllers (C1, C2, C3) comprise at least one of:
a milking controller operatively connected to a milking parlor,
a cleaning controller operatively connected to a cleaning arrangement configured to perform a clean-in-place procedure in respect of at least a part of the milking parlor, and
a cooling controller operatively connected to a cooling tank configured to hold extracted milk

11. The method according to claim 10, wherein:
the milking parlor further comprises at least one milking point that is connected to a vacuum source, at least one pulsator and at least one milk meter, and the milking controller is configured to monitor the at least one milking point, the vacuum source, the at least one pulsator and at the least one milk meter; and
the cooling tank comprises at least one agitating member, an evaporator and a compressor; and the cooling controller is configured to monitor the at least one agitating member, the evaporator and the compressor.

12. The method according to claim 7, further comprising:
obtaining, in the portable computer (130), a respective status message (S(C1), S(C2), S(C3)) while the portable computer (130) is connected to each given one of the configurable controllers (C1, C2, C3), either directly or via the first local server (120) and the first local network (125), said status respective message (S(C1), S(C2), S(C3)) indicating at least one of:
a respective current said configuration of the configurable controller (C1, C2, C3), and
at least one time stamped measurement value registered by the given configurable controller (C1, C2, C3);
and
transferring, from the portable computer (130), a status file (S{C1,C2,C3}) to the central server (110) while the portable computer (130) is connected to the central server (110), said status file (S{C1,C2,C3}) comprising at least one of said respective status messages (S(C1), S(C2), S(C3)).

13. A non-volatile computer readable medium on which is stored a computer program comprising software for executing the method according to claim 7 when the computer program (225) is run on a processing unit (210).

14. (canceled)

15. The milking plant system according to claim 1, wherein the portable computer (130) is configured to obtain a respective status message (S(C1), S(C2), S(C3)) while the portable computer (130) is connected to each given one of the configurable controllers (C1, C2, C3), either directly or via the first local server (120) and the first local network (125), said respective status message (S(C1), S(C2), S(C3)) indicating at least one time stamped measurement value registered by the given configurable controller (C1, C2, C3).

16. The milking plant system of claim 15, wherein the portable computer (130) is configured to transfer a status file (S{C1,C2,C3}) to the central server (110) while the portable computer (130) is connected to the central server (110), said status file (S{C1,C2,C3}) comprising at least one of said respective status messages (S(C1), S(C2), S(C3)).

17. The method according to claim 7, further comprising:
obtaining, in the portable computer (130), a respective status message (S(C1), S(C2), S(C3)) while the portable computer (130) is connected to each given one of the configurable controllers (C1, C2, C3), either directly or via the first local server (120) and the first local network (125), said status respective message (S(C1), S(C2), S(C3)) indicating at least one time stamped measurement value registered by the given configurable controller (C1, C2, C3);

18. The method of claim 17, further comprising transferring, from the portable computer (130), a status file (S{C1,C2,C3}) to the central server (110) while the portable computer (130) is connected to the central server (110), said status file (S{C1,C2,C3}) comprising at least one of said respective status messages (S(C1), S(C2), S(C3)).
